(19) United States
(12) Patent Application Publication
(10) Pub. No.: US 2010/0014067 A1
(43) Pub. Date: Jan. 21, 2010

(54) DETECTION OF AIRBORNE PARTICULATES

(76) Inventors: Karen Louise Baxter, Wiltshire (GB); James McDonald Clark, Wiltshire (GB); Timothy Graham Foat, Wiltshire (GB); Emma Jane Virginia Foot, Wiltshire (GB); Simon Toby Parker, Wiltshire (GB)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/377,296

(22) PCT Filed: Aug. 13, 2007
(86) PCT No.: PCT/GB2007/003072

§ 371 Date: May 4, 2009

(30) Foreign Application Priority Data
Aug. 14, 2006 (GB) 0616080.8

(51) Int. Cl. G01N 1/00

(52) U.S. Cl. 356/36

(57) ABSTRACT

The present disclosure provides method and apparatus for detection of airborne particulates. Liquid droplets comprising reagents capable of reacting with particulates whereby to produce emitted light are introduced to an air flow comprising particulates, whereupon the particulates and liquid droplets agglomerate thereby producing the emitted light. The light is detected by a suitable detector (7), and agglomeration may be enhanced by application of an oscillating electric field (6). The disclosure is particularly concerned with detection of biological particulates.

This invention relates to method and apparatus for detection of airborne particulates, and particularly detection of biological particulates.

Technologies and apparatus for detection of airborne biological particulates, such as bacterial cells, bacterial spores and viruses are currently in great demand, especially with the emergence of antibiotic resistant bacterial species, such as methicillin resistant Staphylococcus aureus (MRSA), and also the threat of bioterrorism.

Detection of airborne biological particulates is more often than not dependent on a requirement for collection of particulates into a liquid phase. This is chiefly to ensure retention of structural integrity and/or activity which is often required for obtaining an accurate result. Detection systems currently available however, are effectively mobile laboratories, requiring huge quantities of liquid and reagents, and a high power input. There is therefore a requirement for improved systems that are smaller, require less reagents and less power, and can operate more flexibly.

The present invention generally aims to provide an instrument capable of detecting biological particulates without the need to collect the particulates from airborne suspension into a bulk liquid.

As commonly understood and also as used herein, a particulate is a solid or liquid substance relating to, or existing in the form of a single particle or plurality of particles. An aerosol is a gaseous suspension, or cloud, of particulates. A liquid droplet may in some circumstances be considered a particulate however, in general a liquid droplet is a droplet.

Detection of particulates in the atmosphere is an important area of scientific research, especially particulates of less than 10 μm in diameter which are acknowledged as a major health risk, causing damage by travelling deep into the lungs, or even entering the bloodstream. Biological particulates, such as bacterial cells, bacterial spores, fungi spores, viruses, and fragments thereof, are particularly problematic since they comprise diameters of between about 0.5 μm to 5 μm.

Elimination and removal of airborne particulates from the atmosphere is conventionally achieved by electrostatic precipitation. However, the collection efficiency of electrostatic precipitators, especially for particulates of less than 10 μm in diameter, has traditionally been difficult. The collection efficiency has however been dramatically improved by incorporating electrostatic agglomeration prior to precipitation (J. F. Hughes et al, Proceedings of the 3^{rd} ICESP 1987, 337-342). Electrostatically charged liquid droplets have been shown to increase the agglomeration, and thereby precipitation, of dust particles over the use of non-charged liquid droplets. Agglomeration is facilitated by increased contact between liquid droplets and particles as a result of electrostatic attraction forces (L. F. Gaunt et al, J. Electrostatics 2003, 58, 159-169). Inductively charged water drops have also been used to agglomerate and precipitate smoke particles from the air (W. Balachandran et al, J. Electrostatics 2001, 51-52, 193-199). Charging of particles and aerosols can be achieved by numerous methods, such as photovoltaic excitation, static electrification, radioactive ionisation, flame charging, diffusion charging and field charging. Diffusion charging and field charging involve bombardment with unipolar ions. This can be achieved by using corona discharge whereby air molecules are ionised in the region of a highly charged electrode.

As used herein, agglomeration is a process whereby particulates and liquid droplets aggregate or merge. Agglomeration can occur naturally by close proximity of particulates and liquid droplets, such as with mixing of particulates and liquid droplets, however the efficiency of agglomeration can be improved by manipulation of characteristics such as, but not restricted to, pressure, temperature, and electrostatic charge. Agglomeration is used in many industries, such as fertilizer production, nuclear fuel, ceramics, lightweight aggregate production, catalysts, pesticides and pharmaceutical products.

The submicron particle collection efficiency of an electrostatic precipitator has also been improved by using a low frequency alternating current (AC) electric field, encouraging electrostatic agglomeration of bipolar-charged particles and water droplets. Water droplets give a large agglomeration coefficient due to a large dielectric constant (Y. Koizumi et al J. Electrostatics 2000, 48, 93-101). For effective electrostatic agglomeration of submicron particles, the size and charge of the liquid droplets should be large compared to the submicron particles.

An AC unipolar charger is an instrument comprising discharge electrodes for ionisation of molecules, and grids to which an AC electric field can be applied (J. E. J. Dalley et al Aerosol Science 2005). Such a charger is suitable for improving the efficiency of agglomeration of particulates and liquid droplets. The discharge electrodes maximise charge, whilst the AC field, in addition to facilitating agglomeration, minimises losses to the walls of the charger. An example of an AC unipolar charger includes the boxer charger (S. Masuda et al Proceedings of the IEEE/IAS Annual Meeting, Toronto, Canada 1978, 16-22).

Even though improvements have been made to instruments for collection of submicron particles, a number of limitations remain, especially the requirement for collection of particles into a bulk liquid, which requires huge quantities of liquid and reagents, and a high power input. There is a need for smaller instruments that require less reagents and less power, and can operate more flexibly.

Accordingly, in a first aspect, the present invention provides a method for detection of airborne particulates, comprising
i) arranging for an air flow comprising the particulates
ii) generating liquid droplets comprising one or more reagents capable of reacting with the particulates whereby to produce mitted light;
iii) introducing the liquid droplets into the air flow whereby to agglomerate them together with the particulates therein; and
iv) detecting the emitted light from the air flow.

As used herein, an airborne particulate is a particulate in a suspension of air, and includes, but is not limited to, particulates of a chemical or biological nature.

In a preferred embodiment, the particulates have mean diameter of between about 0.1 μm to about 10 μm. The particulates are preferably biological particulates i.e. particulates of a biological nature or origin, for example, viruses, bacterial cells, bacterial spores and particulates of plant origin. The particulates may have mean diameter of between about 0.5 μm to about 5 μm, in particular, about 0.5 μm to about 3 μm.

Electrostatic agglomeration is more effective where the size of the liquid droplet is large compared to the size of the particulate. Accordingly, in one embodiment the mean diameter of the liquid droplet is about an order of magnitude larger than that of the particulate. In a highly preferred embodiment, the liquid droplet has mean diameter between 10 μm and 120 μm.

The air flow may be arranged for by any suitable means, including, but not limited to, wind tunnel technology, cyclone technology, and use of natural air flows resulting from meteorological conditions, especially fluctuations in air pressure.

In one embodiment, the generation of the liquid droplets and their introduction to the air flow is performed at substantially the same time.

It will be understood, however, that the rate of air flow must be optimised to the particular particulate and liquid droplet scenario. The air flow is preferably of a flow rate between about 0.1 lmin⁻¹ to about 100 lmin⁻¹, more preferably of between about 1 lmin⁻¹ to about 50 lmin⁻¹, and most preferably between about 10 lmin⁻¹ to about 25 lmin⁻¹. A sheath air flow may be introduced to prevent turbulence and where applicable contain the air flow in the centre of an oscillating electric field.

The liquid droplets comprise one or more reagents capable of reacting with the particulates to produce emitted light, thus upon agglomeration the particulates and the reagents react to produce the emitted light. As used herein, one or more reagents capable of reacting with the particulates to produce emitted light includes, but is not limited to, reagents capable of producing fluorescence, chemiluminescence, bioluminescence and phosphorescence. The reagents may also include recognition elements, such as antibodies, capable of providing specificity to the method for detection. The emitted light comprises light understood by the skilled person to be capable of being produced in a fluorescent, chemiluminescent, bioluminescent of phosphorescent reaction, and preferably comprises light in the visible part of the electromagnetic spectrum. The light is produced rapidly. One example of bioluminescence is the reaction of the reagents luciferin and luciferase with the biological molecule adenosine triphosphate (ATP), found, for example, in a bacterial cell.

Agglomeration can occur naturally through close proximity of particulates and liquid droplets however, agglomeration can be enhanced by application of an oscillating electric field, preferably an AC electric field. Thus, in a preferred embodiment an oscillating electric field is applied to the air flow.

The efficiency of agglomeration in an oscillating electric field is dependent on mean particulate diameter. Particulates of mean diameter higher than 10 μm are more difficult to control during passage through the oscillating electric field, with deposition of agglomerated particulates at the oscillating field grids becoming a major problem.

The oscillating electric field preferably utilises a field strength of between about 25 kV/m to about 400 kV/m, and more preferably between about 100 kV/m to 250 kV/m, whilst the frequency of the oscillating field is preferably between about 4 Hz to about 1000 Hz, more preferably about 300 Hz to about 500 Hz, and most preferably about 400 Hz. It will be understood that the oscillating electric field must be optimised to the particular particulate and liquid droplet scenario. Highly charged liquid droplets of diameter of about 30 μm oscillate in a 225 kV/m and 400 Hz AC electric field. Liquid droplets of diameter between about 10 μm to about 120 μm can be successfully oscillated within an oscillating electric field by optimisation of the field strength and frequency.

The period for agglomeration and detection to occur is dependent on mean particulate diameter, mean liquid droplet diameter, rate of air flow, rate of production of liquid droplets, and where applicable oscillating electric field strength and oscillating electric field frequency. The optimum rate of air flow for particulates of mean diameter 2 μm and liquid droplets of mean diameter 30 μm is about 0.1 ms⁻¹. The period of time for production of the emitted light, once agglomeration is achieved, is thus preferably less than 1 s, more preferably less than 10 ms, and most preferably of the order of μs. It will also be understood that all parameters are dependent on each other, and that the optimum conditions for particular particulate or liquid droplet sizes must be identified and/or determined experimentally.

Agglomeration of the particulates with the liquid droplets comprising reagents capable of reacting with the particulates to produce the emitted light enables detection whilst in the airborne phase or air flow. The benefits of this process include a significant reduction in the quantity of reagents required, and removal of any requirement for a high power collector to capture airborne particulates into a bulk liquid sample. The emitted light is also produced rapidly by the one or more reagents, due in part to the small volume of liquid, in each liquid droplet, within which the particulate must agglomerate.

In a further preferred embodiment the method comprises producing or inducing electrostatic charge within the liquid droplets, particulates, or both liquid droplets and particulates. The electrostatic charge in the liquid droplets is preferably of an opposite net charge to the electrostatic charge in the particulates. Liquid droplets and particulates rapidly become highly charged when exposed to a high concentration of unipolar ions, such as those produced by corona discharge electrodes. An instrument suitable for producing charge in liquid droplets is an AC unipolar charger, such as a boxer charger. Such an instrument combines corona discharge with an AC electric field, enabling control and manipulation of the discharge polarity. Liquid droplets and particulates are preferably proximate prior to producing an electrostatic charge, and thus both particulates and liquid droplets will simultaneously be exposed to a high concentration of unipolar ions. However, since the particulates are in general of smaller diameter than the liquid droplets the particulates will acquire less charge and be less mobile in an AC electric field. The larger liquid droplets will be more mobile, oscillate with larger amplitude and sweep up the smaller particulates. The charge collected on a 1 μm particulate is extremely small at AC unipolar charger parameters optimal for a 30 μm liquid droplet, and the repulsive force between particulates and liquid droplets is likely to be minimal, with the sweeping movement of the liquid droplets being the dominant force in particulate collection.

Agglomeration of particulates and liquid droplets is more efficient with liquid droplets of mean diameter higher than that of the particulates, especially when facilitated by an oscillating electric field, and more especially when the particulates or liquid droplets also possess an electrostatic charge. The method is most efficient with liquid droplets of mean diameter of between about 10 μm to about 120 μm, and especially and preferably with liquid droplets of mean diameter of between about 30 μm to about 70 μm.

The rate of generating liquid droplets is dependent on the flow rate of liquid through the means for generating liquid droplets. The flow rate is preferably between about 20 μlmin⁻¹ to about 250 μlmin⁻¹. Instrumentation suitable for producing liquid droplets of the desired diameter includes the Ultrasonic nozzle (Sonotec Inc), which produces the desired liquid droplet size irrespective of the liquid passed through the nozzle. This simple apparatus has no need for a high voltage supply or a compressed air source.

Charged liquid droplets of mean diameter of about 30 μm effectively sweep up airborne particulates of about 1 μm in diameter, such as viruses, bacterial cells, and bacterial spores, when exposed to an oscillating electric field. The particulates form dipoles as the larger charged liquid droplets approach, and thus agglomeration is further aided by attraction of the oppositely charged pole of the particulate to the charged liquid droplet.

In a second aspect, the present invention provides apparatus for performing the method of the first aspect, comprising
i. one or more reagents capable of reacting with particulates whereby to produce emitted light;
ii. means for generating liquid droplets comprising the one or more reagents;
iii. means for arranging for an air flow comprising the particulates;
iv. means for introducing the liquid droplets into the air flow; and
v. means for detecting the emitted light from the air flow.

In a preferred embodiment the apparatus further comprises means for enhancing agglomeration of the liquid droplets and the particulates in the air flow. Agglomeration is preferably enhanced by means comprising an oscillating electric field or by means of a turbulent air flow. Means for generating liquid droplets is preferably by means of an ultrasonic nozzle or electrospray.

In a preferred embodiment the apparatus further comprises means for producing an electrostatic charge within liquid droplets, particulates or liquid droplets and particulates. This is preferably by means of a source of unipolar ions, and most preferably by means of an AC unipolar charger, such as a boxer charger. Electrostatic charge could alternatively be induced in the liquid droplets, particulates or liquid droplets and particulates by means of a high voltage ring.

In a preferred embodiment the means for producing an electrostatic charge and means for enhancing agglomeration is the same means, more preferably an AC unipolar charger and most preferably a boxer charger.

The present invention will now be described with reference to the following non-limiting examples and drawings in which

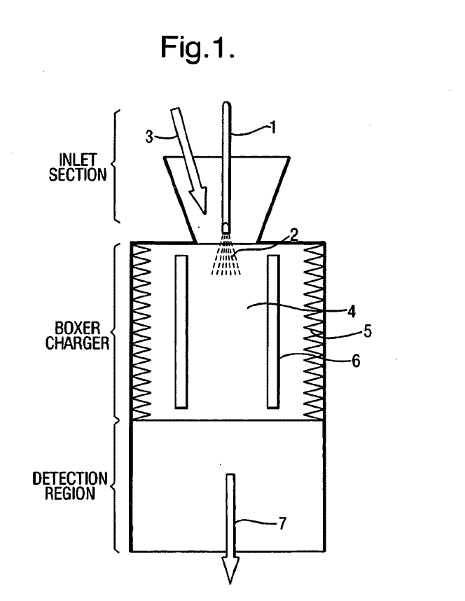

FIG. 1 is a schematic of one embodiment of the apparatus for performing the method;

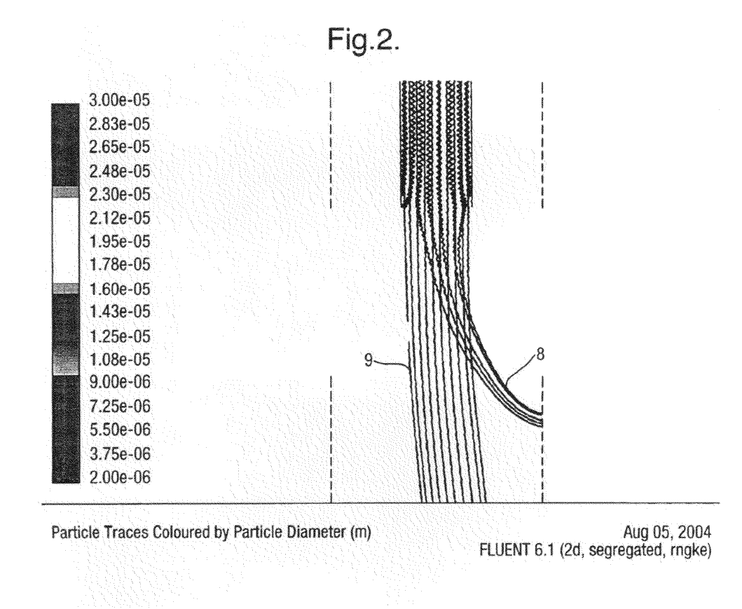

FIG. 2 is a graphical representation of the movement of charged liquid droplets 8 (30 μm) and particulates 9 (2 μm) in an AC electric field, followed by deflection in a DC electric field region, derived by CFD modelling;

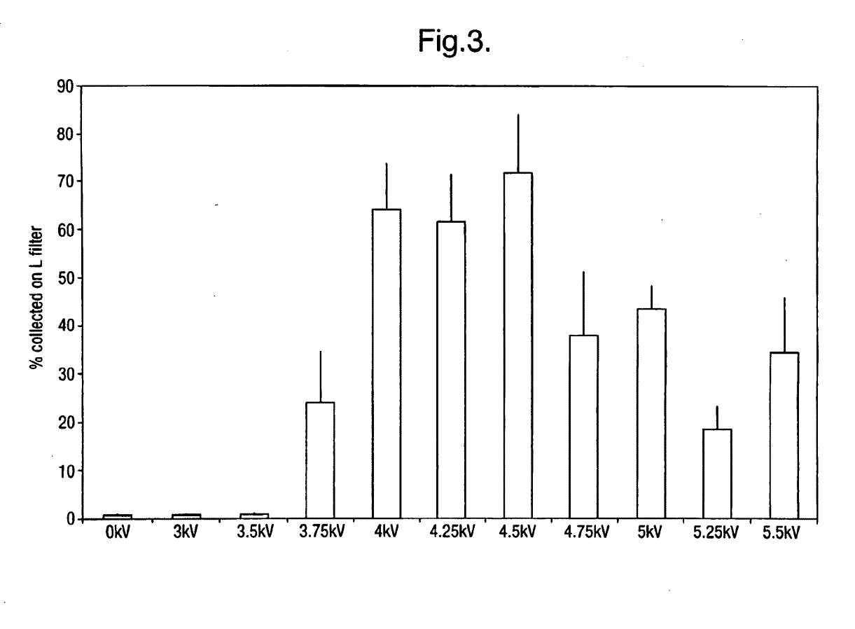

FIG. 3 is a graph of percentage of fluoroscein particulates collected on a DC field filter against AC electric field strength, indicating efficiency of agglomeration of particulates (2 μm) and liquid droplets (30 μm);

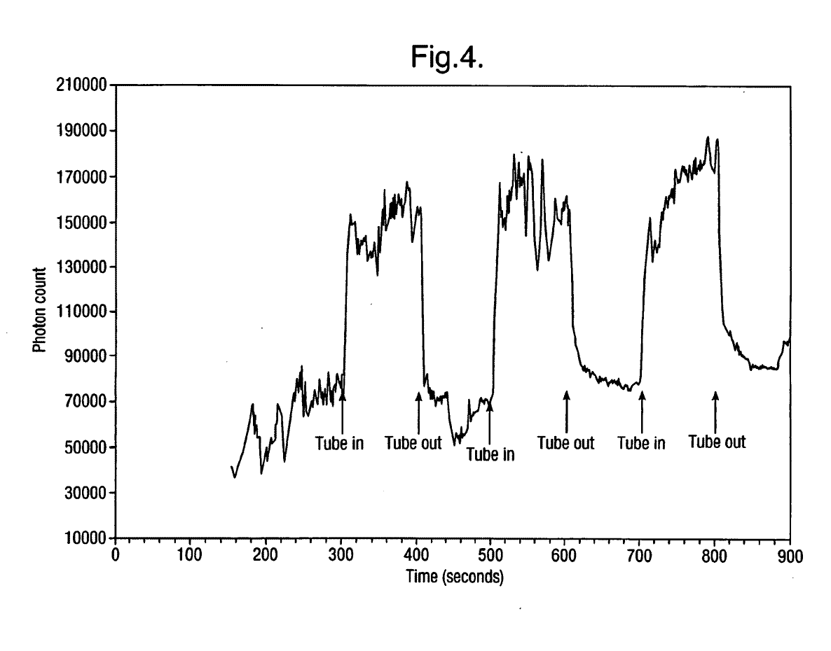

FIG. 4 is a graph indicating increase in photon count upon introduction of luminol particles (tube in) to a boxer charger comprising haematin liquid droplets, with an AC electric field of strength 4.5 kV between two electrodes that are 2 cm apart (225 kV/m) and frequency of 400 Hz;

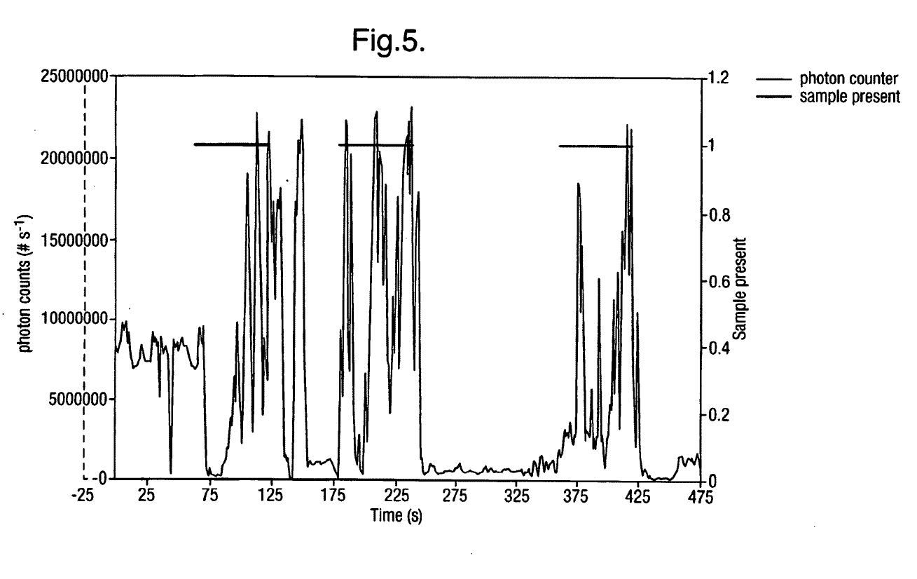

FIG. 5 is a graph as in FIG. 4 with an applied AC electric field of field strength 5 kV between two electrodes that are 2 cm apart (250 kV/m) and a frequency of 400 Hz, with a higher rate of production of liquid droplets;

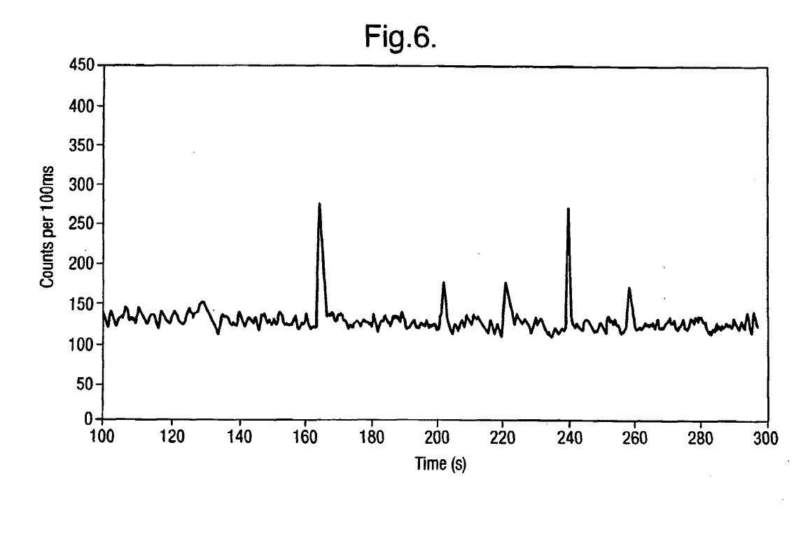

FIG. 6 is a graph showing light emission (photon counts per 100 ms) by single haematin liquid droplets released every 20 seconds upon combination or agglomeration with luminol particles;

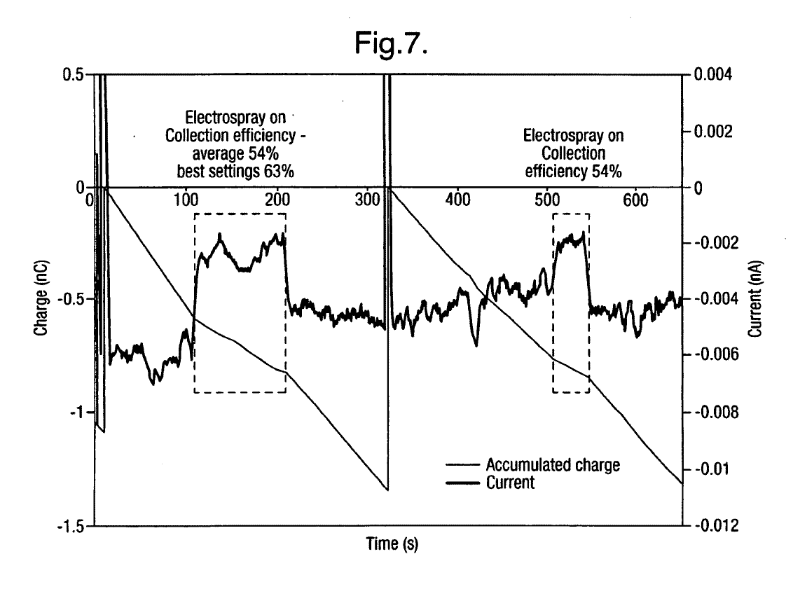

FIG. 7 is a graph showing current measured at a Faraday pail due to an aerosol of small particulates. Marked areas indicate the periods during which liquid droplets were produced. During which the level of particulates reaching the Faraday pail reduced by 54-63%;

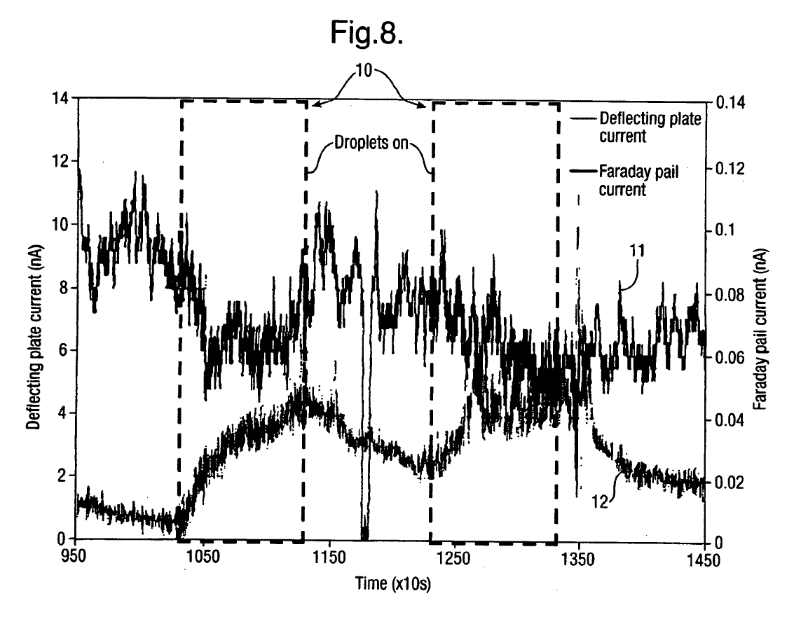

FIG. 8 is a graph showing current measured at a Faraday pail and the current measured at a deflecting plate. Marked areas 10 indicate the periods during which liquid droplets were produced. During which small particulates reaching the Faraday pail reduced by 23-30% and large agglomerates recorded at the deflecting plate increased. The darker trace 11 is faraday pail current and the lighter line 12 is deflecting plate current;

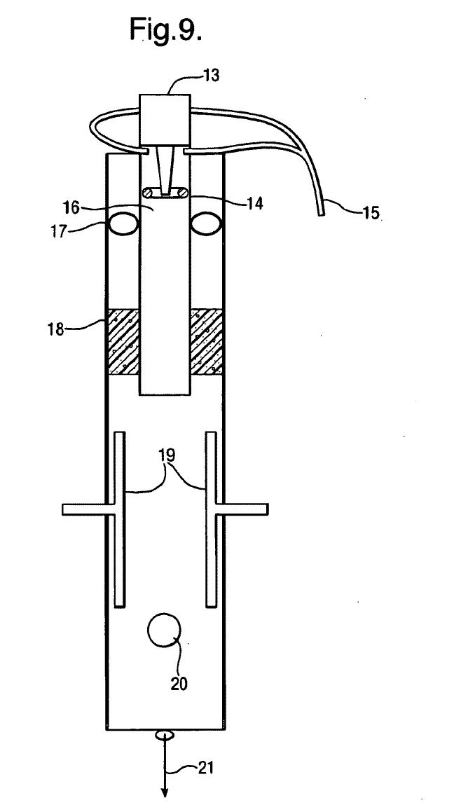

FIG. 9 is a schematic of one embodiment of the apparatus without a boxer charger for performing the method;

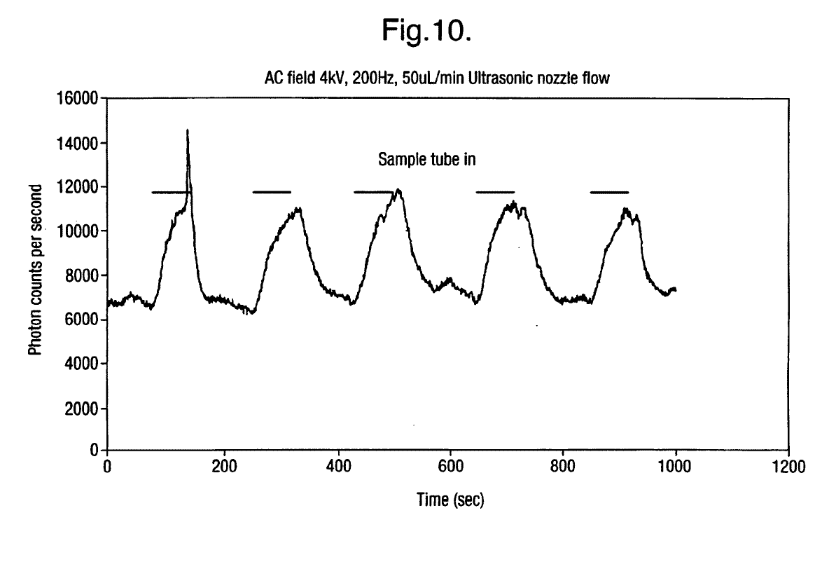

FIG. 10 is a graph showing an increase in photon count following introduction of luminol particles to apparatus of FIG. 8 comprising haematin liquid droplets; and

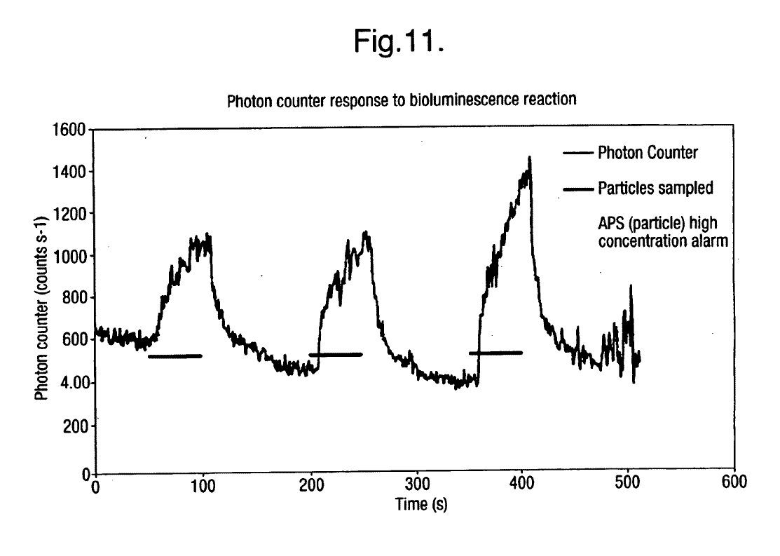

FIG. 11 is a graph showing an increase in photon count following introduction of luciferin particles to apparatus of FIG. 8 comprising horseradish peroxidase liquid droplets.

Referring now to FIG. 1, apparatus according to a first embodiment of the present invention comprises an inlet section containing an ultrasonic nozzle 1 for generating liquid droplets 2, a boxer charger comprising corona pins 5 for producing negative ions, AC electric field generating grids 6, and thereby an AC electric field comprising negative ions 4, and a detection region. An air flow comprising particulates 3 is capable of being admitted to the apparatus whereby agglomeration of particulates and liquid droplets is facilitated by 4. The airflow comprising agglomerates 7 is analysed in the detection region. The detection region may comprise a DC field for deflection of agglomerates to filters or a photon counter for direct detection of an optical parameter produced upon agglomeration of particulates and liquid droplets.

Referring now to FIG. 9, apparatus according to a second embodiment of the present invention comprises an ultrasonic nozzle 13, such as a Sonotec Ultrasonic nozzle, for providing a spray of liquid droplets, positioned protruding into the top of a vertical Perspex tube of 8 cm diameter and 1 m length. The apparatus further comprises a high voltage ring 14 for optionally inducing an electrostatic charge, an inlet tube 15 for providing airflow comprising particulates, a perforated inlet ring tube 17 for providing a sheath air flow, and an inner tube 16 of diameter 4 cm and length 30 cm for channelling the airflow, supported by open cell foam 18. Two AC electric field copper planar electrodes 19 (4 cm by 11 cm) are provided 6 cm apart on either side of the Perspex tube, and 5 cm from the base of 16 for facilitating agglomeration of liquid droplets and particulates. A photon counter 20 is located below 19. The apparatus also comprises an outlet 21.

### EXAMPLE 1

Now having regard to FIG. 1, the efficiency of particulate and liquid droplet agglomeration was investigated using the setup shown in the schematic, using fluorescein molecules as tracer particles (the particulates). Particulates (2 μm diameter) were generated by a mini-nebuliser, and liquid droplets of deionised water (30 μm diameter) were generated by an ultrasonic nozzle with a liquid flow rate of 50 μlmin⁻¹. The total air flow rate was 15 lmin⁻¹, comprising a sheath air flow rate of 14.4 lmin⁻¹ and a sample air flow rate of 0.6 lmin⁻¹. The detection region comprised two DC electrodes, wrapped in filter paper, at either side of the airflow. A DC electric field of 100 kV/m was applied to the electrodes in order to deflect the exiting particulates, liquid droplets and agglomerates. The DC electric field strength was set at a level whereupon the liquid droplets and agglomerates were deflected sufficiently to deposit on the filter papers. The DC field strength was set based on CFD modelling

Having regard to FIG. 2, the water droplets oscillate faster, and with a higher amplitude in the AC electric field than the smaller particulates. On exiting the AC electric field and thereupon being exposed to the DC electric field, the liquid droplets and agglomerates 8 are deflected towards the filter paper covered electrodes, whilst the particulates 9 continue straight through the field. Thus, agglomerated fluorescein particles are deposited on a filter paper at an electrode, and non-agglomerated fluorescein particles continue through the DC electric field and are collected on an in-line filter at the exit of the system.

Having regard to FIG. 3, the efficiency of agglomeration of fluoroscein particles and water droplets, at varying AC electric field strengths, was calculated by comparing the mass of fluorescein deposited at the electrode filters when liquid droplets were being sprayed, to the mass deposited during control runs (no liquid droplets sprayed). Parameters such as liquid flow rate (controlling the number of liquid droplets produced) and boxer charger frequency were also optimised using this set up. The optimum set up for agglomeration of fluoroscein particles (2 μm diameter) in water droplets (30 μm diameter) was a gas flow rate of 15 lmin⁻¹, an AC electric field strength of 4.5 kV between two electrodes that are 2 cm apart (225 kV/m) and a AC field frequency of 400 Hz, with production of liquid droplets at a liquid flow rate of 50 μlmin⁻¹. The efficiency of agglomeration was 72%.

### EXAMPLE 2

Detection of agglomerates has been demonstrated in the airborne phase using the combination of boxer charger, chemiluminescent reaction and photon counter. Oxidation of luminol particles by haematin liquid droplets is affected by agglomeration, resulting in light emission. Sucrose was used as a carrier for luminol, providing particles of mean diameter 1 μm. Emitted photons were counted with a photon counter detector (Hamamatsu) located below the boxer charger.

Now having regard to FIGS. 4 and 5, it has been demonstrated that light emitting liquid droplets can be detected in the airborne phase when using the combination of a boxer charger with a 400 Hz AC electric field of 225 kV/m, an ultrasonic nozzle for production of haematin liquid droplets at a liquid flow rate of between 50 and 150 μL/min and airflow through the system comprising luminol particles, following subtraction of any background light level. The total air flow rate was 15 l/min, comprising a sheath air flow rate of 12.4 l/min and sample flow rate of 3.4 l/min. Luminol particles of mean diameter 1 μm were introduced to the boxer charger from a mini-nebuliser. The photon counter repeatedly detected an increase in light levels due to emission of light from agglomerated particles. The light intensity sharply decreased upon ceasing production of particles, proving the increase in light was due to agglomeration of particles, and not deposition of chemiluminescent components from the liquid droplets on the surfaces of the device.

Having regard to FIG. 6, it has also been demonstrated that detection of single light emitting liquid droplets can be achieved in the airborne phase when using the combination of a boxer charger with a 400 Hz AC electric field of 225 kV/m. Single haematin liquid droplets were introduced into the apparatus at 20 second intervals, with luminol particles delivered via the inlet. The synchronised appearance of emitted light with the release of a liquid droplet indicates that a single liquid droplet has combined or agglomerated with one or more particles, thus demonstrating optical detection within a single liquid droplet.

### EXAMPLE 3

Electrostatic charging of liquid droplets was identified as a further method of manipulating the agglomeration mechanism. An electrospray instrument was used to produce charged liquid droplets. It incorporated a 50 μm fused silica capillary and a grounded ring electrode. The size distribution of the liquid droplet spray was measured by a Malvern Spraytec instrument. All aqueous solutions tested produced a cloud of liquid droplets from the electrospray upon application of an electric field of 6×10⁵ to 2×10⁶ V/m. Liquid droplet size distributions were similar, and of mean diameter 60 μm. The concentration was 5×10⁵ liquid droplets per minute at a liquid flow rate through the electrospray of 10 μl/min. This was difficult to measure directly due to the high charge which caused deposition within the Aerosol Particle Sizer instrument (TSI 3310), however, an approximation was made based on the size distribution measured with the Spraytec instrument (Malvern Instruments Inc.) and the flow rate of liquid.

Particulates (fluoroscein particles of diameter 3 μm) were directed into the boxer charger whereupon they obtained negative charges and began to move in the alternating electric field. An AC electric field strength of between 150 kV/m and 400 kV/m and a frequency of 100 Hz was investigated. The total flow rate was 12 l/min. A positively charged spray of water droplets (30 μm diameter) was then sprayed into the boxer charger. The water droplets were initially of opposite charge, and moved in the opposite direction, to the airborne particles in the AC electric field. This along with particle-particle attraction enhanced particle collection efficiency. Over time, the negative ions from the boxer charger neutralised the liquid droplets and eventually charged them negatively. The 30 μm liquid droplets continued to oscillate in the AC electric field and because mobility is proportional to diameter moved a greater distance than the particulates during each oscillation. This sweeping action of the liquid droplets was the predominant mechanism of liquid droplet/particle agglomeration.

As the particles and liquid droplets exited the boxer charger they were exposed to a DC electric field deflection zone. Liquid droplets and agglomerates were deflected in the DC electric field and removed from the flow by deposition on one electrode, leaving the smaller particles to pass straight through the system, to be detected, by charge, at a Faraday pail. When the liquid droplet spray was active, the Faraday pail measured a reduction in the number of fluoroscein particles passing straight through the instrument, together with increased deposition of fluoroscein particles at the side electrode.

Having regard to FIG. 7, with electrospray active, there was a 54-63% increase in the relative amount of fluorescein depositing at the side electrode, indicating agglomeration.

The experiment was replicated using monodisperse demineralised water droplets of mean diameter 100 μm, produced from a Microdrop spray. A mini-nebuliser was used to produce small salt particles to simulate particulates. The Microdrop spray carries a small charge due to its disruptive method of generation, but does not produce a charge of the magnitude of the electrospray liquid droplets.

Having regard to FIG. 8, with the liquid droplet spray active 10, a reduction in the magnitude of the Faraday pail current 11 was observed indicating agglomeration of particulates. A collection efficiency of 22% was estimated based on the reduction recorded during a number of experiments. This method was most likely less efficient than the electrospray method because of the liquid droplets being deposited within the boxer charger region, leaving less liquid droplets to agglomerate the particulates.

### EXAMPLE 4

The chemiluminescent reaction detailed in Example 2 was also facilitated and monitored by using the apparatus of FIG. 9 comprising solely an AC electric field, rather than a boxer charger comprising AC electric field and corona discharge. The ultrasonic nozzle 13 provided a spray of liquid droplets of mean diameter 30 μm, with no additional charging of the liquid droplets, other than the charge inherently produced during the ultrasonic spraying process. Sample air, comprising luminol particles, was pulled into inner tube 16 at a flow rate of 5 l/min. The sheath air flow was 18 l/min and the total airflow was 35 l/min. An AC electric field of 67 kV/m and 200 Hz was established between the electrodes 19.

Now having regard to FIG. 10, agglomeration of particulates and liquid droplets in the airborne phase brings about an increase in the light emitted. Thus, even without additional charging of the liquid droplets, agglomeration in the airborne phase can be achieved and detected. Agglomeration is however likely to be enhanced by inductively increasing the charge on the liquid droplets.

### EXAMPLE 5

Agglomeration and detection of biological particulates in the airborne phase was illustrated using the apparatus depicted in FIG. 9 together with liquid droplets comprising reagents for producing bioluminescence. The set-up for the instrumentation was as in Example 4. The liquid droplets comprised horseradish peroxidase type VI-A, hydrogen peroxide, and a Tris.HCl buffer (0.1 M; pH 8.0). The particulates comprised the biologically derived molecule luciferin, sucrose as carrier particle and huminol. An AC electric field of 67 kV/m and 200 Hz was utilised.

Now having regard to FIG. 11, the photon count (indicative of the bioluminescent reaction) increased upon introduction of particulates into the instrumentation. Thus agglomeration and detection in the airborne phase was enabled for a biological particulate.

1. A method for detection of airborne particulates comprising
i. arranging for an air flow comprising the particulates;
ii. generating liquid droplets comprising one or more reagents capable of reacting with the particulates whereby to produce emitted light;
iii. introducing the liquid droplets into the air flow whereby to agglomerate them together with the particulates therein; and
iv. detecting the emitted light from the air flow.

2. A method according to claim 1, in which an oscillating electric field is applied to the air flow.

3. A method according to claim 2, in which the electric field has strength between about 25 kVm⁻¹ to about 400 kVm⁻¹.

4. A method according to claim 1, further comprising producing or inducing electrostatic charge within the liquid droplets, particulates, or both liquid droplets and particulates.

5. A method according to claim 1, in which the particulates have mean diameter of about 0.1 μm to about 10 μm.

6. A method according to claim 1, in which the liquid droplets have mean diameter of between about 10 μm to about 120 μm.

7. A method according to claim 1, in which the air flow has a flow rate of between about 0.1 lmin⁻¹ to about 100 lmin⁻¹.

8. A method according to claim 1, in which ii and iii are performed at the same time.

9. A method according to claim 1, in which the particulates are biological particulates.

10. A method according to claim 9, in which the biological particulates are of a viral or bacterial origin.

11. A method according to claim 10, in which the emitted light is in the visible part of the electromagnetic spectrum.

12. Apparatus for performing the method of claim 1, comprising
i. one or more reagents capable of reacting with particulates whereby to produce emitted light;
ii. means for generating the liquid droplets comprising the one or more reagents;
iii. means for arranging for an air flow comprising the particulates;
iv. means for introducing the liquid droplets into the air flow; and
v. means for detecting the emitted light from the air flow.

13. Apparatus according to claim 12, further comprising means for enhancing agglomeration of the liquid droplets and the particulates in the air flow.

14. Apparatus according to claim 13, in which the means for enhancing agglomeration comprises an oscillating electric field.

15. (canceled)
